(19) United States
(12) Patent Application Publication
(10) Pub. No.: US 2015/0264911 A1
(43) Pub. Date: Sep. 24, 2015

(54) Insect Trap

(71) Applicant: James Moad, Calgary (CA)

(72) Inventor: James Moad, Calgary (CA)

(21) Appl. No.: 14/219,179

(22) Filed: Mar. 19, 2014

(51) Int. Cl. A01M 1/04

(52) U.S. Cl. CPC A01M 1/04

(57) ABSTRACT

The insect trap includes a funnel body having wide open end and an opposite narrow open end. A cover is attached to the funnel body and is disposed at a vertical spaced distance from the wide open end and forms a gap between the cover and the wide open end. One or more light sources are positioned on a bottom side of the cover. A striker element is attached to the funnel body and operable to strike upon the funnel body. And, a vacuum hose has a first end connected to the narrow open end of the funnel body and a second end connectable to another vacuum hose of a conventional vacuum cleaner.

### FIELD OF THE INVENTION

The present invention relates generally to insect traps, and more particularly, relating to an illuminated insect trap for use in connection with a vacuum to dispose of the trapped insects.

### BACKGROUND OF THE INVENTION

Insect traps of various types have been developed in the past. More specifically, insect traps heretofore devised and utilized consist of a myriad of designs that have been developed for the fulfillment of countless objectives and requirements. While the devices heretofore fulfill their respective, particular objectives and requirements, they do not provide an insect trap of a new construction that attracts and captures insects as such there exists and need for an insect trap, which substantially departs from the prior art, and in doing so provides an apparatus primarily developed for the purpose of an insect trap that connects to a conventional vacuum for disposal of captured insects.

### SUMMARY OF THE INVENTION

In view of the foregoing disadvantages inherent in the known types of insect traps now present in the prior art, the present invention provides a new insect trap construction wherein the same can be used for attracting, capturing, and disposal of captured insects by a conventional vacuum cleaner.

In general, in one aspect, an insect trap is provided. The insect trap includes a funnel body having wide open end and an opposite narrow open end. A cover is attached to the funnel body and is disposed at a vertical spaced distance from the wide open end and forms a gap between the cover and the wide open end. One or more light sources are positioned on a bottom side of the cover. A striker element is attached to the funnel body and operable to strike upon the funnel body. And, a vacuum hose has a first end connected to the narrow open end of the funnel body and a second end connectable to another vacuum hose of a conventional vacuum cleaner.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of an insect trap constructed in accordance with an embodiment of the present invention;

FIG. 2 is a side elevation view of the insect trap of FIG. 1;

FIG. 3 is a cross-sectional view taken along line 3-3 in FIG. 1, illustrating a connection between vacuum hoses;

FIG. 4 is a cross-section view taken along line 4-4 in FIG. 2; and

FIG. 5 is a side elevation view of an insect trap constructed in accordance with an embodiment of the present invention including an alternative striker.

### DETAILED DESCRIPTION OF THE INVENTION

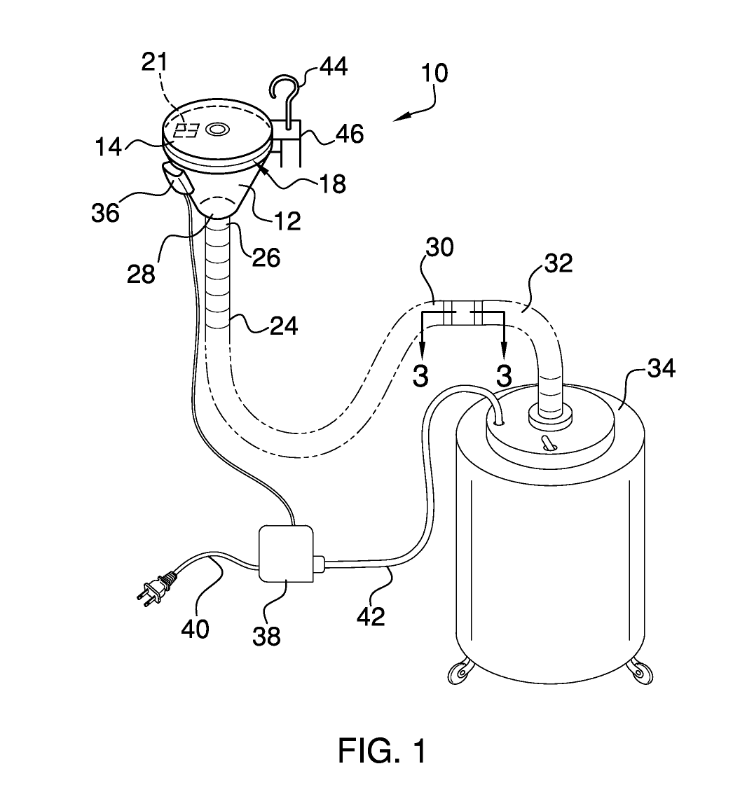

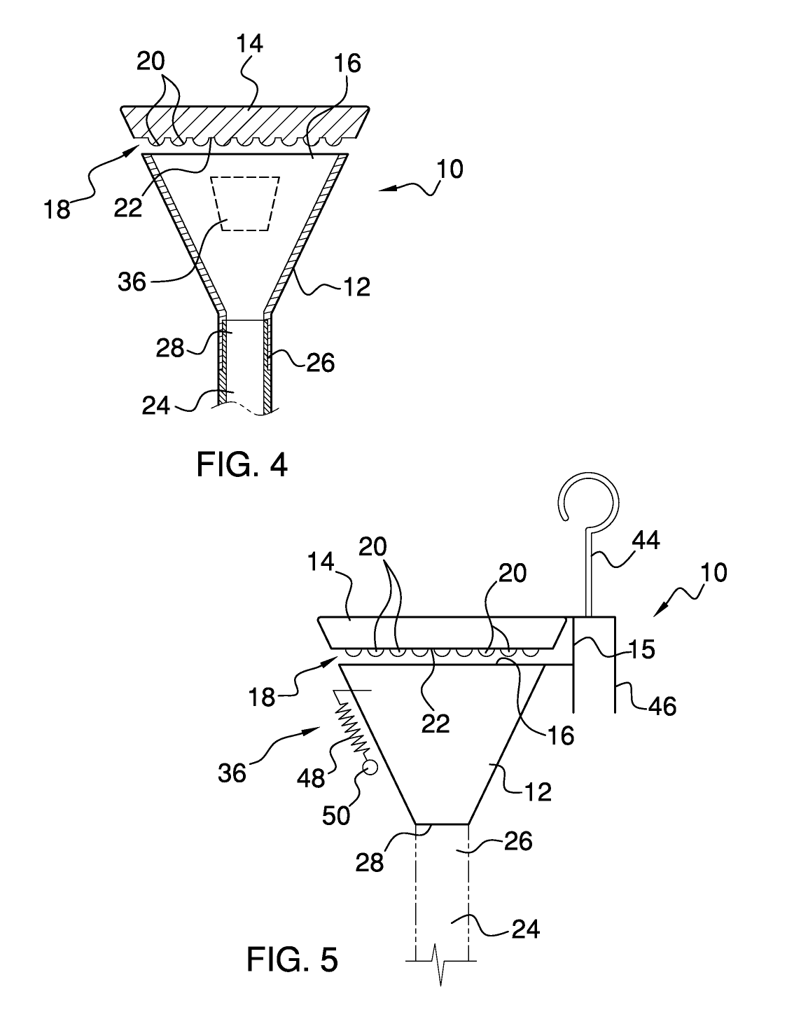

With reference to FIGS. 1-5, there is representatively illustrated a new insect trap 10 in accordance with a least one embodiment of the present invention. With reference to FIGS. 1-4, in one embodiment, the insect trap 10 includes a funnel body 12 and a cover 14 attached to the funnel body by bracket 15 at a vertically spaced distance from the wide, open end 16 of the funnel body, thereby creating a gap 18 between the cover and open end 16. One or more light sources, preferably LED lights 20, powered by batteries 21, are disposed on a bottom side 22 of the cover 14 and are arranged to project light in a direction generally into the open end 16 of the funnel body 12. To this end, insects are attracted to the light from lights 20 and are consequently drawn into the interior of the funnel body 12 through the gap 18 between the cover 14 and the funnel body.

A vacuum hose 24 is attached by a first end 26 thereof to the narrow, open end 28 of the funnel body 12 with its opposite, second end 30 attached to a vacuum hose 32 of a conventional vacuum cleaner 34. As shown in FIG. 3, end 30 of vacuum hose 24 is tapered so that it is able to connect to vacuum hoses of various diameters. To this end, when vacuum cleaner 34 is turned on, insects that have been trapped within funnel body 12 are vacuumed into the vacuum.

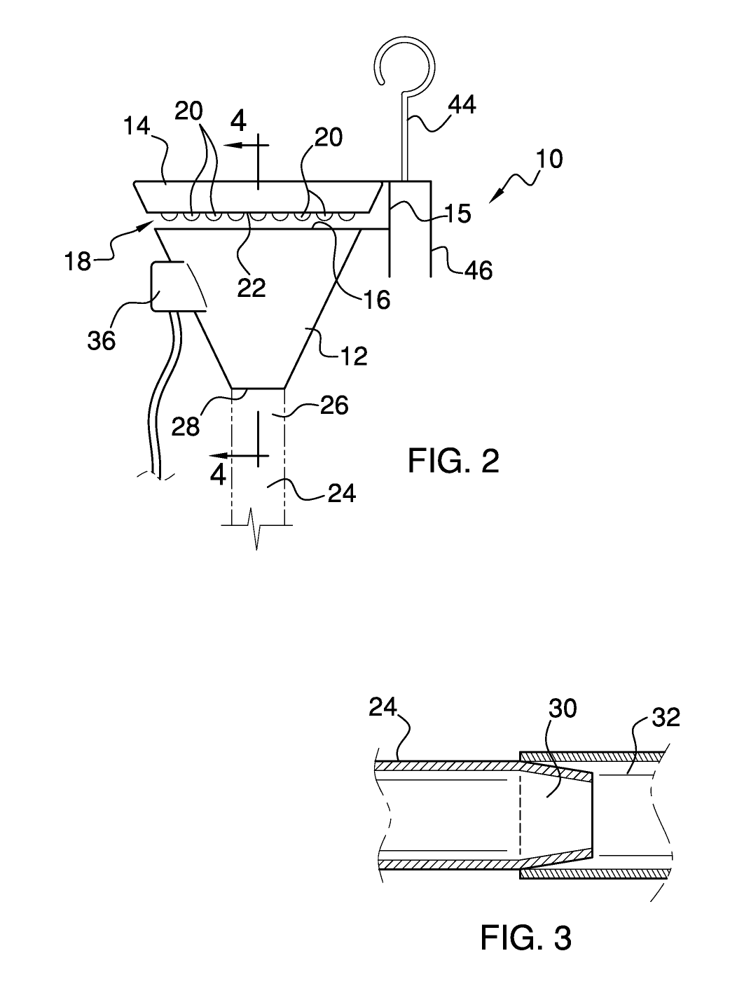

The insect trap 10 further includes a striker 36 attached to the funnel body 12. The striker 36 is operated to impact the funnel body 12 to dislodge insects that are attached to the inner wall of the funnel body so that they are more readily removed by the vacuum 34. As illustrated in FIGS. 1 and 2, the striker 36 is an electrically operated element, such as, for example, a solenoid striker, or another electrical or electrical-mechanical striker element.

As further illustrated, the striker 36 is electrically connected to a timer 38. Timer 38 is electrically powered and is plugged into a conventional electrical outlet by power cord 40. In an embodiment, power cord 42 of the vacuum 34 can be plugged into the timer 38. To this end, the timer 38 simultaneously powers the striker 36 and the vacuum 34 at predetermined intervals to vacuum insects from the funnel body 12. It is contemplated, that other, more sophisticated embodiments, sensors that detect the presence of insects within the funnel body could be employed to operate the striker 36, the vacuum 34, or both.

The insect trap 10 includes a hanger element 44 attached to the funnel body 12 and extending vertically upward. The Hanger 44 facilitates suspending the funnel body 12 from a support structure. The insect trap 10 may also include a door hanger 46 attached to the funnel body 12 to permit hanging the funnel body from the top edge of a door. As illustrated, the hanger element 44 is attached to and extends upwardly from the door hanger 46, which in turn is connected to both the funnel body 12 and the cover 14 by bracket 15.

In FIG. 5, the insect trap 10 is shown with the electrical striker element 36 replaced by a manual striker element 36′. Striker element 36′ includes a spring element, such as, for example, a coil spring 48 attached at one end thereof to the funnel body 12 with a ball bearing 50 or the like attached to the opposite end. In operation, a user would simply pull back upon and release the ball bearing 50, thereby causing the ball bearing to strike the funnel body 12 by the force of the spring 48.

A number of embodiments of the present invention have been described. Nevertheless, it will be understood that various modifications may be made without departing from the spirit and scope of the invention. Accordingly, other embodiments are within the scope of the following claims.

What is claimed is:

1. An insect trap, comprising:
a funnel body having wide open end and an opposite narrow open end;
a cover attached to said funnel body and disposed at a vertical spaced distance from said wide open end and forming a gap between said cover and said wide open end;
one or more light sources on a bottom side of said cover;
a striker element attached to said funnel body and operable to strike upon said funnel body; and
a vacuum hose having a first end connected to said narrow open end of said funnel body and a second end connectable to another vacuum hose.

2. The insect trap of claim 1, wherein said striker element is an electrically operated element.

3. The insect trap of claim 2, further comprising:
an electrically operated timer; and
wherein said striker element is electrically connected to said electrically operated timer.

4. The insect trap of claim 1, wherein said striker element is a manually operated element.

5. The insect trap of claim 1, wherein said second end of said vacuum hose is tapered.

6. The insect trap of claim 1, further comprising:
a hanger element connected to said funnel body.

7. The insect trap of claim 1 further comprising:
a door hanger connected to said funnel body.

8. The insect trap of claim 1, further comprising:
a hanger element connected to said funnel body; and
a door hanger element connected to said funnel body.

9. The insect trap of claim 1, wherein said one or more light sources are light emitting diodes.

10. An insect trap, comprising:
a funnel body having wide open end and an opposite narrow open end;
a cover attached to said funnel body and disposed at a vertical spaced distance from said wide open end and forming a gap between said cover and said wide open end;
a vacuum hose having a first end connected to said narrow open end of said funnel body and a second end connectable to another vacuum hose;
one or more light sources on a bottom side of said cover;
an electrically operated striker element attached to said funnel body and operable to strike upon said funnel body;
an electrically operated timer electrically connected to said electrically operated striker element; and
at least one of a hanger element and a door hanger.
